(19) United States
(12) Patent Application Publication
(10) Pub. No.: US 2026/0361017 A1
(43) Pub. Date: Nov. 12, 2026

(54) LOCKOUT TAGOUT BRACKET FOR ELECTRICAL CONNECTORS

(71) Applicant: Norman R. Byrne, Ada, MI (US)

(72) Inventors: Gerald N. Vander Till, Grandville, MI (US); Joseph Luedtke, Grand Rapids, MI (US); Marc A. Mitchell, Jupiter, FL (US); Martin J. Stemen, Greenville, MI (US); Parker Genau, Grand Rapids, MI (US); Timothy J. Warwick, Sparta, MI (US)

(21) Appl. No.: 19/666,718

(22) Filed: May 4, 2026

Related U.S. Application Data
(60) Provisional application No. 63/800,982, filed on May 6, 2025.

(51) Int. Cl. H01R 13/44; H01R 13/631

(52) U.S. Cl. CPC H01R 13/44; H01R 13/631

(57) ABSTRACT

A bracket for electrical connectors enables an operator to secure electrical connectors together, such as during normal operation of equipment utilizing the electrical connectors, and/or to limit or preclude access to electrical contacts of one or more electrical connectors, such as during servicing or maintenance of the equipment, or while one of the electrical connectors has only a subset of its electrical contacts in use.

### CROSS REFERENCE TO RELATED APPLICATION

The present application claims the benefit of U.S. provisional application Ser. No. 63/800,982 filed May 6, 2025 which is hereby incorporated herein by reference in its entirety.

### FIELD

The present invention relates to lock-out brackets for limiting or precluding the functional use of electrical connectors on at least a temporary basis.

### BACKGROUND

Lockout/Tagout ("LOTO") practices and equipment are used in industry to control access to hazardous energy, such as high voltage electricity or electrically operated equipment that could cause harm or injury if energized during maintenance or other non-standard operations. A "lockout" device is a lock that can be installed to prevent undesired release of electrical or mechanical energy, and typically can only be removed by personnel with a key or the like. A "tagout" device is a label or warning, typically placed on a switch or other shut-off device, that warns not to energize or tamper with the equipment while the tag is in place. Tagout devices may be designed to be removable only with an intentional act such as cutting or untwisting a wire or tie. A tagout device can typically be easily removed without tools, or with only a basic hand tool, and thus relies on training and compliance by personnel to provide effective safety, whereas a lockout device can only be removed by personnel with a compatible key, combination, specialized tool, or the like.

### SUMMARY

The present disclosure is directed to brackets for electrical connectors, which enable an operator to secure two or more electrical connectors together and/or to limit or preclude access to electrical contacts of one or more electrical connectors. Securing electrical connectors together is useful during normal operation of equipment utilizing the electrical connectors, while limiting or precluding access to electrical contacts may be useful either during normal operations when only a subset of electrical contacts of a connector are in use, or during servicing or maintenance of the equipment when the electrical connector(s) should be isolated from all sources of electrical power.

According to one form, a bracket for electrical connectors includes a two-piece enclosure made up of first and second enclosure portions that cooperate to define first and second open portions or cavities for receiving first and second connectors. The first enclosure portion has a first tab extending distally toward the second enclosure portion, and the second enclosure portion has a second tab extending distally toward the first enclosure portion. The second enclosure portion defines a slot near its second tab. The first tab is sized and shaped to extend outboard of the second tab and through the slot during assembly of the first and second enclosure portions around the first and second connectors.

In one aspect, the first tab includes a distal end portion that extends outwardly from the slot upon assembly of the first and second enclosure portions. The distal end portion of the first tab defines an opening for receiving a tag or a lock.

In another aspect, the second enclosure portion includes a third tab corresponding to the second tab and located oppositely thereof.

According to another aspect, the second tab has a distal end including a first latch, the first enclosure portion defines a corresponding first latch receiver aligned with the first tab, the first latch receiver is sized and shaped to receive the first latch upon assembly of the first and second enclosure portions, and the first latch and the first latch receiver cooperate with one another to secure the first enclosure portion to the second enclosure portion.

In yet another aspect, the second enclosure portion includes a third tab corresponding to the second tab and located opposite the second tab. The third tab has a distal end including a second latch. The first enclosure portion defines a corresponding second latch receiver aligned with the second tab. The second latch receiver is configured to receive the second latch upon assembly of the first and second enclosure portions. The second latch and the second latch receiver cooperate to secure the first enclosure portion to the second enclosure portion.

In a further aspect, at least one of the first and second enclosure portions includes a pair of spaced-apart elongate retention elements for engaging respective retention elements along the first and second connectors. Engagement of the retention elements of the first and/or second enclosure portions, with the retention elements of the first and/or second connectors, causes the first connector to be retained in engagement with the second connector. Optionally, the spaced-apart elongate retention elements of the first and second enclosures are in the form of linear recessed channels.

According to another form, lockout bracket for electrical connectors a base plate, an outwardly-extending plate coupled to the base plate, and a shroud. The outwardly-extending plate has first and second laterally spaced-apart openings. The shroud is sized and shaped to be mounted over portions of the base plate, the outwardly-extending plate, and an electrical connector that is securable to the base plate and to the outwardly-extending plate. The shroud includes first and second outwardly-extending pockets, a recess defined between the pockets, and a U-shaped slot formed along the recess. The first outwardly-extending pocket disposed around a first region of the outwardly-extending plate surrounding the first opening, the second outwardly-extending pocket is spaced apart from the first pocket by the recess, the recess being disposed along a second region of the outwardly-extending plate surrounding the second opening. The U-shaped slot is sized and shaped to receive the outwardly-extending plate surrounding the second opening. The second opening of the outwardly-extending plate is exposed at the recess when the shroud is placed along the base plate. The second opening is configured to receive a lock or a tag for securing the shroud to the outwardly-extending plate.

In one aspect, the shroud defines a channel along the first outwardly-extending pocket and spaced apart from the recess. The channel is aligned with the first opening of the outwardly-extending plate when the second opening is exposed at the recess, and the first opening is configured to receive a threaded fastener for securing the shroud to the outwardly-extending plate. Optionally, the channel has a wider upper region and a narrower lower slot region extending downwardly from the wider upper region.

In another aspect, the shroud includes a cord channel opposite the first and second outwardly-extending pockets that span a width greater than the cord channel width. The cord channel is sized and shaped to resist pull-out of the electrical connector relative to the outwardly-extending plate.

According to yet another form, bracket for electrical connectors includes a lockout bracket, a second bracket, and a fastener. The lockout bracket is positionable near a first electrical connector, the lockout bracket having a first upward-extending leg section defining a fastener opening and a second upward-extending leg section defining a lockout opening. The first and second leg sections lie in respective first and second planes that are spaced apart from one another to define a gap therebetween. Optionally, the first and second planes are parallel to one another. The second bracket is positionable near a second electrical connector that is configured for coupling to the first electrical connector, the second bracket having a distal portion cantilevered laterally from a proximal portion. The proximal portion of the second bracket defines a fastener opening configured to align with the fastener opening of the lockout bracket, and the distal portion of the second bracket defines a lockout opening configured to align with the lockout opening of the lockout bracket. The fastener is configured to pass through the fastener openings and to threadedly engage at least one of the fastener openings. The second bracket is received in the gap defined between the first and second planes of the first and second leg sections. The lockout bracket is releasably securable to the second bracket by the fastener, and the second bracket is lockable to the lockout bracket by a locking element disposed through the lockout openings of the lockout bracket and the second bracket.

In one aspect, a cover bracket is provided that is positionable over the first electrical connector and having an upwardly-directed leg defining a fastener opening that aligns with the fastener openings of the lockout bracket and the second bracket. The cover bracket further defines a lockout opening that aligns with the lockout openings of the lockout bracket and the second bracket. Optionally, the lockout bracket defines a slot below one of the upward-extending leg sections, and the cover bracket includes a projecting tab configured for insertion into the slot.

Thus, the brackets described herein provide redundant lock-out capability such that both a fastener, which may be removable using a standard tool, and a lock member, which may be removable with a key, by setting a combination, or with a specialized tool. These arrangements allow for substantially any operator to set at least a limited lock-out function for the bracket, while also providing the option to allow only authorized operators (i.e., those with the key, combination, authorized biometrics, or specialized tool) to set a higher level lock-out function.

These and other objects, advantages, purposes and features of this invention will become apparent upon review of the following specification in conjunction with the drawings.

### BRIEF DESCRIPTION OF THE DRAWINGS

FIG. 1 is a perspective view of a connector assembly with two sets of electrical cable assemblies and a bracket for providing security at the connector assembly;

FIG. 2 is a partially-exploded perspective view of the bracket with connector assembly and electrical cable assemblies of FIG. 1;

FIG. 3 is an enlarged side elevation view of the connector assembly and bracket of FIG. 1;

FIG. 4 is an enlarged side elevation view of the partially-exploded bracket and connector assembly of FIG. 2;

FIG. 5 is a perspective view of another bracket for providing security at another electrical connection;

FIG. 6 is a perspective view of the partially-exploded bracket and electrical connection of FIG. 5;

FIG. 7 is an enlarged side elevation view of the connector assembly and electrical connection of FIG. 5;

FIG. 8 is an enlarged side elevation view of the partially-exploded bracket and electrical connection of FIG. 6;

FIG. 9 is a perspective view of another bracket for providing security at another electrical connection; and

FIG. 10 is a perspective view of the partially-exploded bracket and electrical connection of FIG. 9.

### DETAILED DESCRIPTION

Referring now to the drawings and illustrative embodiments depicted therein, lockout tagout brackets are provided for enhancing safety of workers in the area of electrical connectors and equipment utilizing the electrical connectors and associated wiring. The brackets allow operators to secure two or more electrical connectors together, or to limit or preclude access to electrical contacts of one or more electrical connectors. The brackets can be used during normal equipment operation by helping to maintain electrical connections and/or by precluding undesired contact with unused (but potentially electrically "live" or "hot") electrical contacts of a connector having other contacts in active use. The brackets can also be used to entirely block or prevent electrical connections that could be harmful during servicing or maintenance of the equipment or the electrical wiring or associated connections. The brackets can receive lock-out devices that may be released with a special tool, key, biometric input, combination entry, or the like, and the brackets can also be attached less securely with a fastener that can be removed with a basic hand tool or potentially with no tool at all.

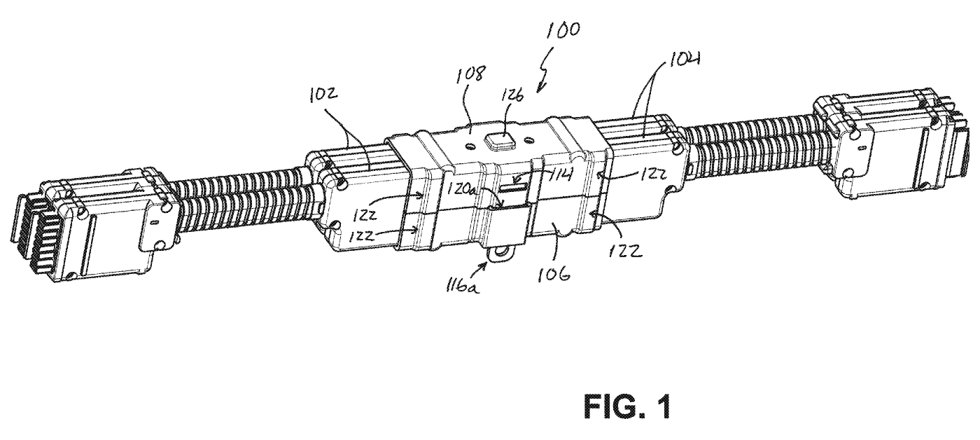

Referring now to FIGS. 1-4, a lockout tagout bracket 100 is designed to secure a first set of electrical connectors 102 to a second set of electrical connectors 104. Bracket 100 is made up of two shells or housing portions including a lower shell or housing portion 106 and an upper shell or housing portion 108. The lower shell 106 includes a pair of upwardly-directed resilient latch projections 110 that are received in respective central channels 112 of the upper shell 108, with ramped end portions 110a that engage respective latch slots 114 formed in the upper shell 108 at the central channels 112. Upper shell 108 includes a downwardly-extending lockout tab 116 with a lockout opening 118 formed at its lower or distal end portion 116a. Lockout tab 116 is received through a lockout tab slot 120 that is formed at a central region of lower shell 106, the lockout tab slot 120 having an upper opening 120a formed at a base of the resilient latch projection 110, and a lower opening 120b formed directly below the upper opening 120a along a bottom surface of the lower shell 106. Optionally, and as shown, lower shell 106 is symmetrical including a lockout tab slot 120 at each opposite side, so that the lower shell 106 may be attached to the upper shell 108 in either of two orientations.

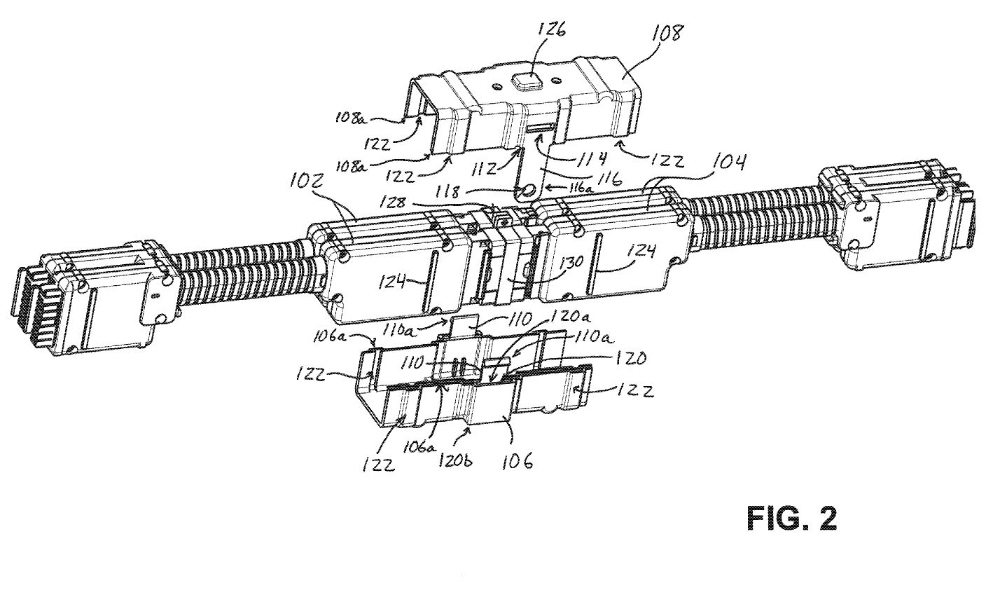

Both shells 106, 108 include a set of elongate retention elements in the form of four ridge-receiving channels 122 that are sized, shaped, and positioned to receive corresponding elongate retention elements in the form of respective ridges 124 along the outboard side of each electrical connector 102, 104, such as shown in FIG. 2. Upper and lower shells 106, 108 each include an outwardly-extending central portion 126 forming an outwardly-extending recess for receiving a pair of outwardly-extending abutments 128 of an optional securing band 130 that extends around the electrical connection interface where first electrical connectors 102 mate with second electrical connectors 104. Once the first electrical connectors 102 are mated with second electrical connectors 104 and the optional securing band 130 is attached, lower shell 106 is slid up from below so that its four channels 122 receive lower end portions of the four respective ridges 124 of the electrical connectors 102, 104. Similarly, the upper shell 108 is slid down from above so that its four channels 122 receive upper end portions of the four respective ridges 124 of the electrical connectors 102, 104. During this movement the distal end portion 116a of the lockout tab 116 is inserted into the lower shell's lockout tab slot 120 at its upper opening 120a. Upon initial engagement of the upper and lower shells 106, 108 with the connectors' ridges 124, the electrical connectors 102, 104 are secured together against any pull-out forces that may be applied to the connectors 102, 104 or their associated cords or other structures.

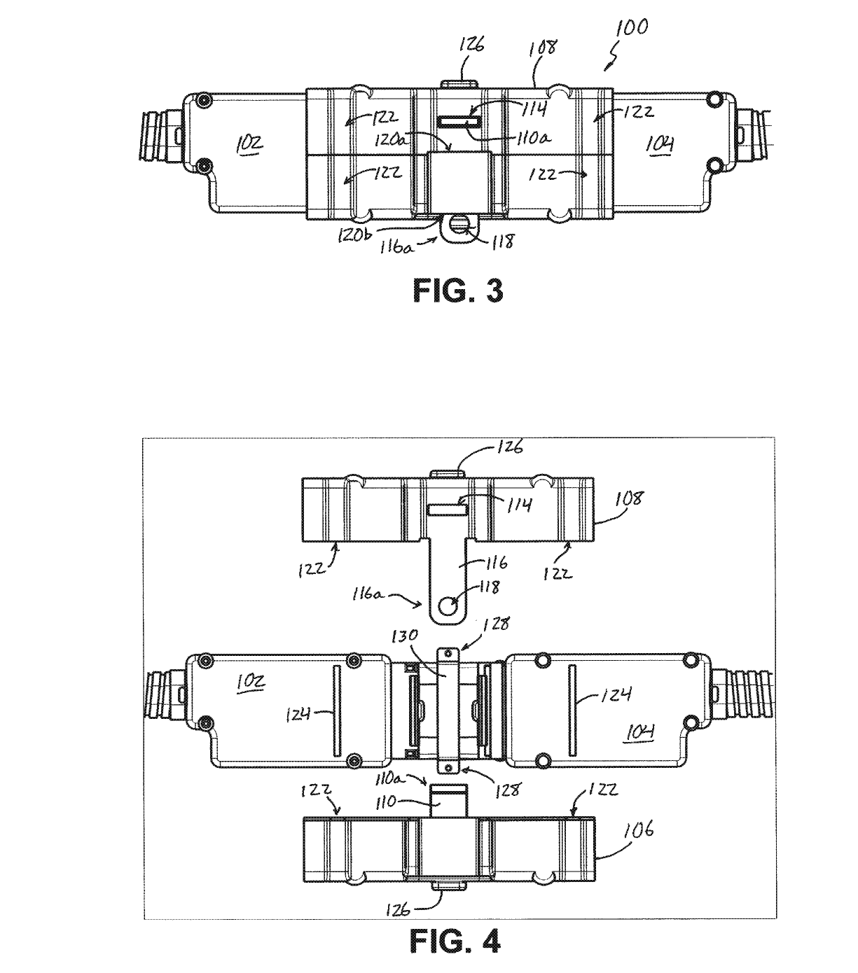

By moving the shells 106, 108 closer together until touching or in close proximity along their respective upper and lower edges, the ridges 124 are fully received in the channels 122, the ramped end portions 110a of resilient latch projections 110 are received in the respective latch slots 114, and the lockout tab's distal end portion 116a and lockout opening 118 are projecting below the lower opening 120b of the lower shell's lockout tab slot 120, such as shown in FIGS. 1 and 3. At this stage lower shell 106 is secured to upper shell 106 by the engagement of ramped end portions 110a in the latch slots 114, thereby securing the electrical connectors 102, 104 together and also enclosing the electrical interface of the connectors 102, 104 to prevent access to the electrical interface (in the vicinity of optional securing band 130) while also limiting or preventing contaminants from reaching the electrical interface. Because of the narrow shape of latch slots 114, separation of the upper and lower shells 106, 108 may require simultaneous insertion of two flat tools (e.g., flat-bladed screwdriver tips) into the two latch slots 114 while pulling the shells 106, 108 apart from one another, in order to separate them and expose the electrical interface. Optionally, a lock or other securing device may be installed through lockout opening 118 when the shells 106, 108 are secured together, so that separating the shells requires first removing the lock or securing device from the lockout opening of the lockout tab 116.

Optionally, and as best shown in FIG. 2, upper edges 106a of lower shell 106 are each formed with a laterally-inset step that is received inside the respective lower edges 108a of upper shell 108, the lower edges 108a including a laterally-inset recess. This allows the upper edges 106a to nest with the lower edges 108a by forming a narrow overlapping region that is further resistant to entry of contaminants. It is further envisioned that soft gasket-forming materials may be placed along interior surfaces of the shells 106, 108 to increase resistance to entry of contaminants to the electrical connector interface.

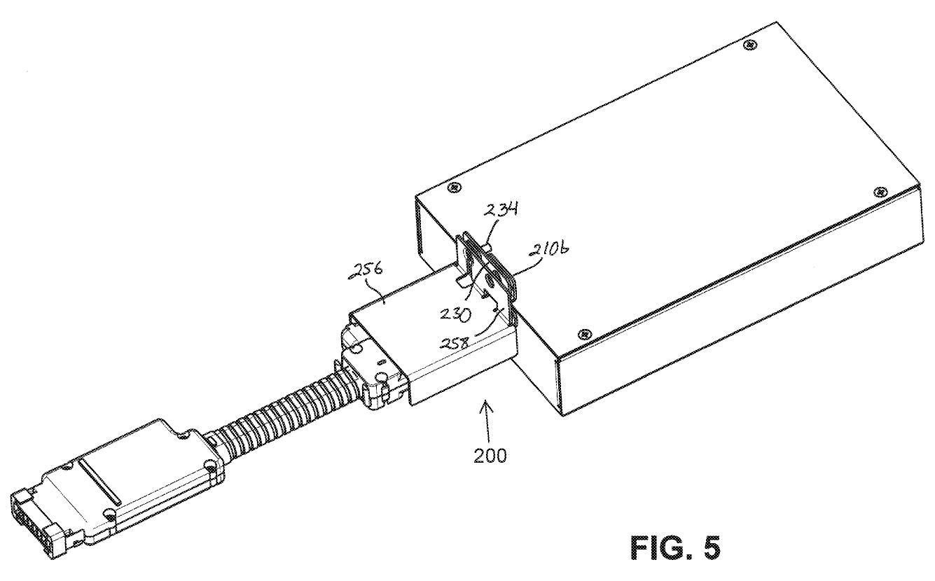

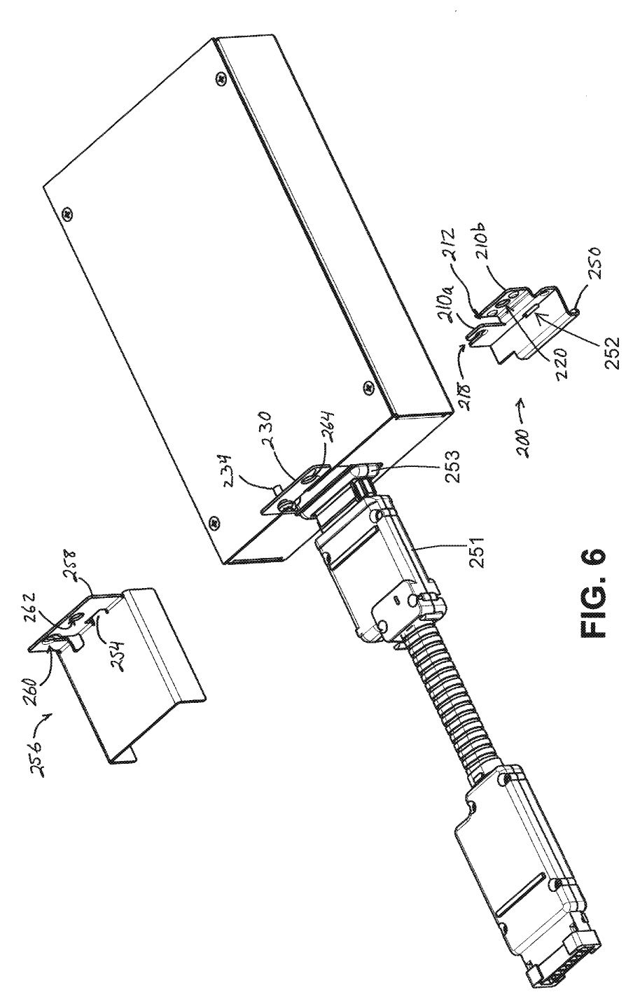

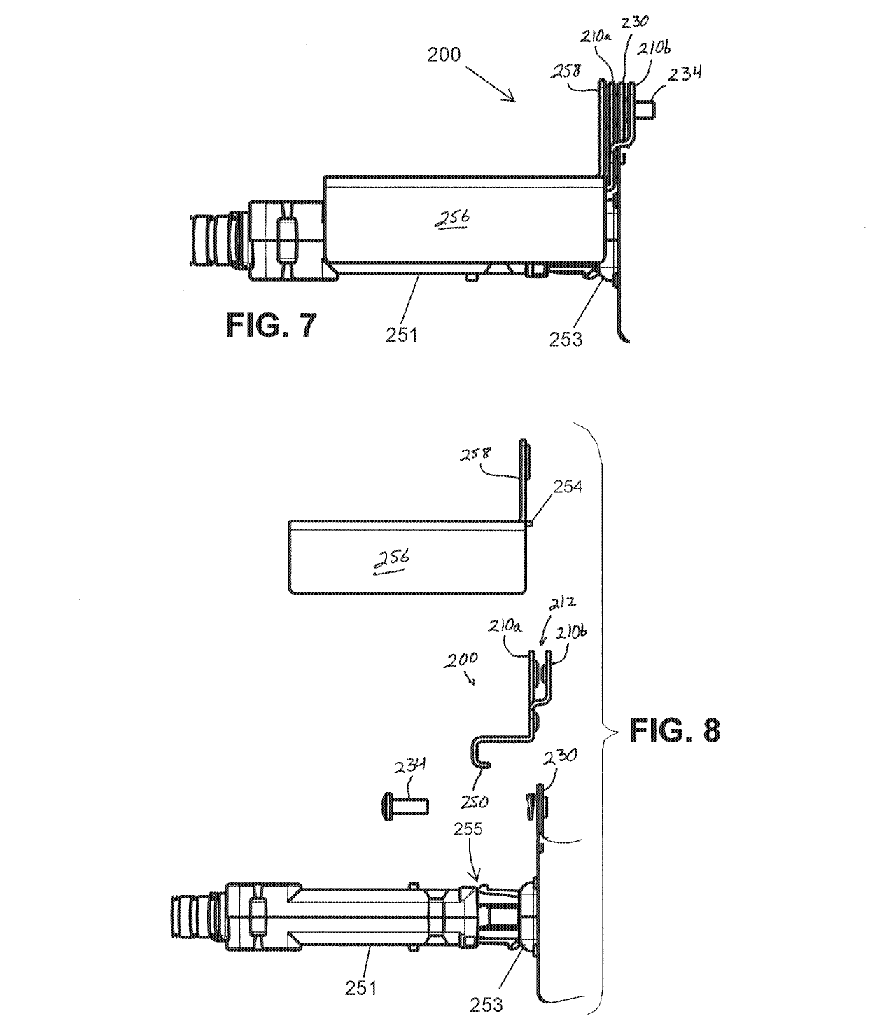

Referring now to FIGS. 5-8, another lockout bracket 200 includes a first leg section 210a and a second leg section 210b that are generally parallel to one another and lie in different spaced-apart planes to define a gap 212 therebetween, as best shown in FIGS. 6 and 8. The first leg section 210a defines a fastener opening 218 that is open to a peripheral edge, and the second leg section 210b defines the lock opening 220. The gap 212 can receive a second bracket body 230 that supports a fastener 234 in a fastener opening 235 of a proximal portion of the second bracket body 230, with the first and second leg sections 210a, 210b of the first leg portion 210 positioned along opposite sides of the second bracket body 230 as shown in FIGS. 5 and 7. The bracket 200 includes a U-shaped retaining flange 250 (FIGS. 6 and 8) configured to engage and secure one electrical connector 251 to another electrical connector 253 when the bracket 200 is positioned at the coupled electrical connectors, as shown in FIGS. 5 and 7. Retaining flange 250 engages a ridge or slot 255 (FIG. 8) in an upper region of the first electrical connector 251, thus securing it to the other electrical connector 253. A slot 252 is formed at a base of second leg section 210b, where it meets U-shaped retaining flange 250. Slot 252 receives a projecting tab 254 of a cover bracket 256 that further includes an upwardly-directed leg 258 with a first hole or fastener opening 260 corresponding to fastener 234 and a fastener opening 218 of first leg section 210a. Upwardly-directed leg 258 further defines a second hole or lock opening 262 corresponding to (aligning with) lock opening 220 of second leg section 210b and also corresponding to (aligning with) an aligned hole or lock opening 264 formed in a distal portion of second bracket body 230 that is cantilevered laterally from the proximal portion.

With the first electrical connector 251 engaged with the second electrical connector 253 as shown in FIG. 6, bracket 200 is positioned with fastener 234 received in fastener opening 218, with lock opening 220 aligned with hole 264, and with U-shaped retaining flange 250 engaged with first electrical connector 251. In this configuration bracket 200 is positioned to retain the first connector 251 to the second connector 253, but would be readily removable by sliding the bracket 200 laterally to disengage fastener 234 from fastener opening 218. At this point a lock, bolt, flexible tie, tamper-evident seal, or the like could be placed through lock opening 220 and hole 264 to secure against removal of bracket 200 from second bracket body 230. In the illustrated embodiment, however, cover bracket 256 is then placed over the bracket 200, first electrical connector 251, and its interface region with second electrical connector 253, as shown in FIGS. 5 and 7. Fastener 234 is received in first hole 260 with the fastener's head remaining exposed, second hole 262 is aligned with lock opening 220, and projecting tab 254 is received in slot 252. In this configuration, first electrical connector 251 and bracket 200 are mostly covered by cover bracket 256, and additional security may be provided by inserting a lock, bolt, flexible tie, tamper-evident seal, or the like through the aligned openings 262, 220, 230. Optionally, a modified bracket similar to bracket 200, but with a vertically-elongated version of retaining flange 250, may be used to block access to second connector 253 when first connector 251 is not connected.

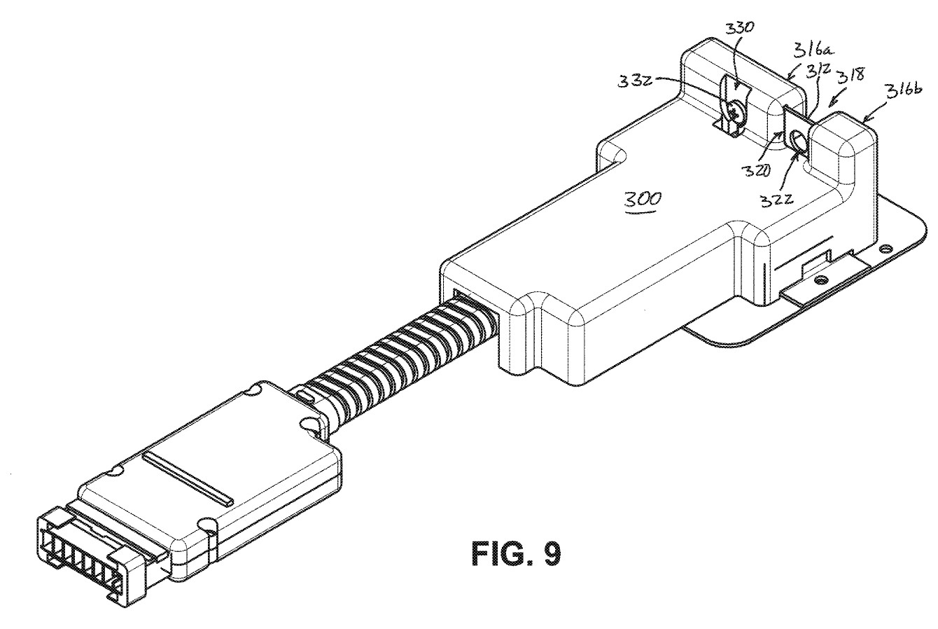

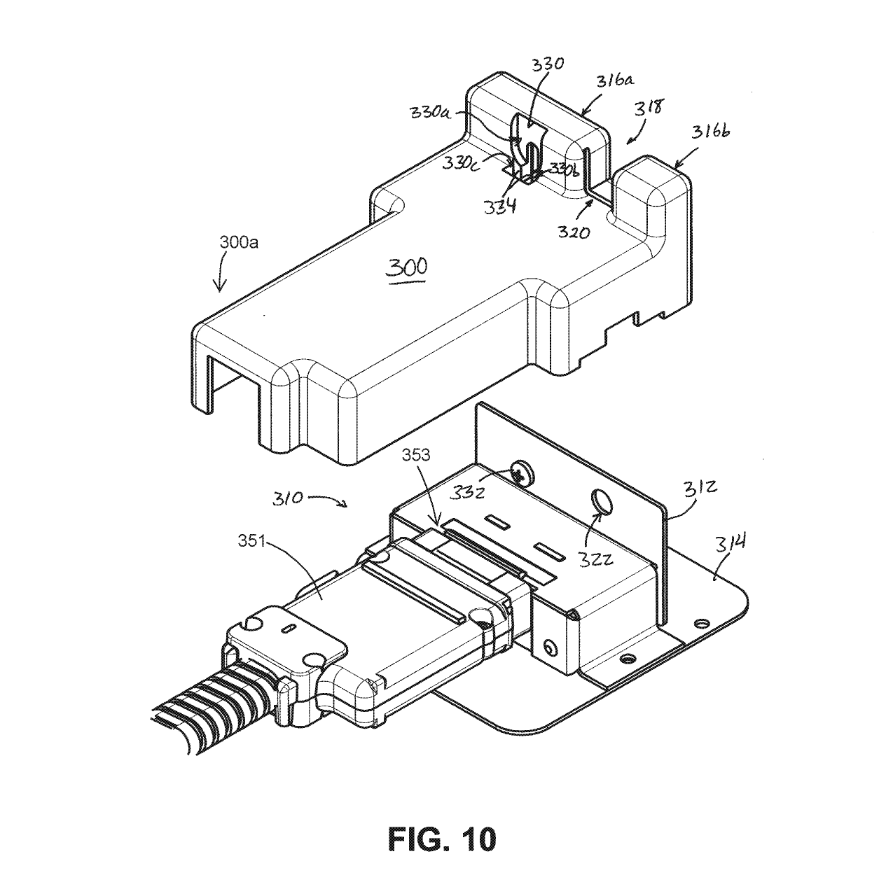

Referring now to FIGS. 9 and 10, a protective shroud 300 is adapted for use with connector interfaces such as those depicted in FIGS. 5-8. Shroud 300 provides protection against contaminants around a connector interface 310 (FIG. 10) and may be secured and optionally locked around the connector interface 310 with only a thin plate 312 that extends outwardly from a base plate 314. Shroud 300 includes a pair of upwardly-extending pockets 316a, 316b with a recess 318 formed between them and a U-shaped slot 320 along the recess 318 that exposes a portion of the plate 312 in the vicinity of a lockout opening 322 that is formed in the plate 312. With shroud 300 installed in this manner, a lock, bolt, flexible tie, tamper-evident seal, or other retaining device may be placed through lockout opening 322 to secure shroud 300 around the connector interface 310 and prevent or discourage inadvertent access to the connector interface 310. Base plate 314 and outwardly-extending plate 312 may also cooperate with each other to preclude access to the connector interface 310.

Additionally, a tagout function may be provided by a channel 330 formed in the first upwardly-extending pocket 316a and a fastener 332 that is securable to outwardly-extending plate 312. Channel 330 includes a wider upper region 330a that is exposed along the first upwardly-extending pocket 316a and is sufficiently wide to receive a head of fastener 332, as shown in FIGS. 9 and 10. A narrower lower slot region 330b extends downwardly from upper region 330a, but includes a wider portion 330c that is sufficiently wide to receive the head of fastener 332 when the fastener is backed out a sufficient distance to clear a pair of shoulders 334 that define the narrower slot region 330b relative to the wider portion 330c (FIG. 10). This allows the fastener 332 to be backed out from plate 312 by a short distance while remaining attached to plate 312, so that the fastener's head may pass through the wider slot portion 330c while its shaft passes through the narrower slot region 330b as the shroud 300 is installed around connector interface 310. The fastener's head will be positioned in the channel's wider upper region 330a when the shroud 300 is fully mated to the base plate 314 and with the outward-extending plate 312 received in the upwardly-extending pockets 316a, 316b and the U-shaped slot 320. At this point the fastener 332 may be tightened so that its head is seated in the wider upper region 330a, which prevents removal of shroud 300 because the fastener's head cannot pass between the shoulders 334 that define the narrower lower slot region 330b. Thus, channel 330 and fastener 332 provide an initial degree of security for connector interface 310, which can be further secured by placing a lock or similar device through lockout opening 322 in the region of the recess 318 between the shroud's of upwardly-extending pockets 316a, 316b. When shroud 300 is installed as shown in FIG. 9, its rear portion 300a, opposite the upwardly-extending pockets 316a, 316b, surrounds a rear portion of a first connector 351 of the connector interface 310, and thus prevents separation of the first connector 351 from a second connector 353 (FIG. 10).

Thus, the lock-out and tag-out devices disclosed herein provide varying levels of protection against separation of interfacing electrical connectors and/or may preclude access to an electrical connector. Initial installation of the devices may provide a visual cue that the electrical connector(s) or their connection is not to be tampered with, and may require a simple tool such as a screwdriver to remove the device, so that the device may not be inadvertently removed or separated from the connector or connection, but must be deliberately removed. The devices provide additional securing options, such as by inserting a lock, a bolt, or a flexible tie or seal, so that only authorized persons may remove a given device.

Changes and modifications in the specifically described embodiments can be carried out without departing from the principles of the present invention which is intended to be limited only by the scope of the appended claims, as interpreted according to the principles of patent law including the doctrine of equivalents.

1. A bracket for electrical connectors comprises:
a two-piece enclosure having first and second enclosure portions cooperating to define first and second open portions for receiving first and second connectors;
said first enclosure portion comprising a first tab extending distally toward said second enclosure portion; and
said second enclosure portion comprising a second tab extending distally toward said first enclosure portion, said second enclosure portion defining a slot proximate said second tab;
wherein said first tab is configured to extend outboard of said second tab and through said slot during assembly of said first and second enclosure portions.

2. The bracket of claim 1, wherein said first tab comprises a distal end portion that extends outwardly from said slot upon assembly of said first and second enclosure portions, wherein said distal end portion of said first tab defines an opening for receiving a tag or a lock.

3. The bracket of claim 1, wherein said second enclosure portion comprises a third tab corresponding to said second tab and located oppositely thereof.

4. The bracket of claim 1, wherein:
said second tab comprises a first latch at a distal end thereof;
said first enclosure portion defines a corresponding first latch receiver aligned with said first tab;
said first latch receiver is configured to receive said first latch upon assembly of said first and second enclosure portions; and
said first latch and said first latch receiver cooperate to secure said first enclosure portion to said second enclosure portion.

5. The bracket of claim 4, wherein:
wherein said second enclosure portion comprises a third tab corresponding to said second tab and located oppositely thereof.
said third tab comprises a second latch at a distal end thereof;
said first enclosure portion defines a corresponding second latch receiver aligned with said second tab;
said second latch receiver is configured to receive said second latch upon assembly of said first and second enclosure portions; and
said second latch and said second latch receiver cooperate to secure said first enclosure portion to said second enclosure portion.

6. The bracket of claim 1, wherein at least one of said first and second enclosure portions comprises a pair of spaced-apart elongate retention elements for engaging respective retention elements along the first and second connectors, and wherein engagement of said retention elements of said at least one of said first and second enclosure portions with the retention elements of the first and second connectors causes the first connector to be retained in engagement with the second connector.

7. The bracket of claim 6, wherein said spaced-apart elongate retention elements of said first and second enclosures comprise linear recessed channels.

8. A lockout bracket for electrical connectors, comprising:
a base plate;
an outwardly-extending plate coupled to said base plate, said outwardly-extending plate comprising first and second laterally spaced-apart openings;
a shroud configured to be mounted over portions of said base plate, said outwardly-extending plate, and an electrical connector that is securable to said base plate and to said outwardly-extending plate, said shroud comprising:
a first outwardly-extending pocket disposed around a first region of said outwardly-extending plate surrounding said first opening;
a second outwardly-extending pocket spaced apart from said first pocket;
a recess defined between said first and second pockets, wherein said recess is disposed along a second region of said outwardly-extending plate surrounding said second opening; and
a U-shaped slot formed in said shroud along said recess, said U-shaped slot configured to receive said outwardly-extending plate surrounding said second opening;
wherein said second opening of said outwardly-extending plate is exposed at said recess when said shroud is placed along said base plate; and
wherein said second opening is configured to receive a lock or a tag for securing said shroud to said outwardly-extending plate.

9. The lockout bracket of claim 8, wherein said shroud defines a channel along said first outwardly-extending pocket and spaced apart from said recess, wherein said channel is aligned with said first opening of said outwardly-extending plate when said second opening is exposed at said recess; and wherein said first opening is configured to receive a threaded fastener for securing said shroud to said outwardly-extending plate.

10. The lockout bracket of claim 9, wherein said channel comprises a wider upper region and a narrower lower slot region extending downwardly from said wider upper region.

11. The lockout bracket of any of claim 8, wherein said shroud comprises a cord channel opposite said first and second outwardly-extending pockets that span a width greater than said cord channel, wherein said cord channel resists pull-out of the electrical connector relative to said outwardly-extending plate.

12. A bracket for electrical connectors comprises:
a lockout bracket positionable proximate a first electrical connector, said lockout bracket having a first upward-extending leg section defining a fastener opening and a second upward-extending leg section defining a lockout opening, wherein said first and second leg sections lie in respective first and second planes that are spaced apart from one another to define a gap therebetween;
a second bracket positionable proximate a second electrical connector that is configured for coupling to the first electrical connector, said second bracket having a distal portion cantilevered laterally from a proximal portion;
said proximal portion of said second bracket defining a fastener opening configured to align with said fastener opening of said lockout bracket, and said distal portion of said second bracket defining a lockout opening configured to align with said lockout opening of said lockout bracket; and
a fastener configured to pass through said fastener openings and to threadedly engage at least one of said fastener openings;
wherein said second bracket is received in said gap defined between said first and second planes of said first and second leg sections; and
wherein said lockout bracket is releasably securable to said second bracket by said fastener, and said second bracket is lockable to said lockout bracket by a locking element disposed through said lockout openings of said lockout bracket and said second bracket.

13. The bracket of claim 12, further comprising a cover bracket positionable over the first electrical connector and having an upwardly-directed leg defining a fastener opening that aligns with said fastener openings of said lockout bracket and said second bracket, and defining a lockout opening that aligns with said lockout openings of said lockout bracket and said second bracket.

14. The bracket of claim 13, wherein said lockout bracket defines a slot below one of said upward-extending leg sections and said cover bracket comprises a projecting tab configured for insertion into said slot.
